(19) United States
(12) Patent Application Publication
(10) Pub. No.: US 2018/0249713 A1
(43) Pub. Date: Sep. 6, 2018

(54) Composition for Protection of Plants, Fruit and Vegetables

(71) Applicant: Liquid Vanity ApS, Ebeltoft (DK)

(72) Inventors: Dan Mønster NIELSEN, Ebeltoft (DK); Per Bendix Jeppesen, Egå (DK)

(21) Appl. No.: 15/756,820

(22) PCT Filed: Sep. 1, 2016
(86) PCT No.: PCT/DK2016/050292

§ 371 Date: Mar. 1, 2018

(30) Foreign Application Priority Data
Sep. 1, 2015 (DK) PA 2015 70568

(51) Int. Cl. A01N 47/44; A01N 33/12

(52) U.S. Cl. CPC A01N 47/44; A01N 25/30; A01N 2300/00; A01N 33/12

(57) ABSTRACT

The present invention concerns a composition comprising a combination of biocides having synergistic effect. The composition is useful for plant protection, in particular the composition is useful as a biocide, such as a pesticide, e.g. useful as a fungicide. The composition can be used alone or in combination with other pesticides/fungicides for plant protection by enhancing the effect of said other pesticide/fungicide.

### FIELD OF INVENTION

The present invention relates to a composition for plant protection, in particular a composition useful as biocide, such as a pesticide, more particularly a composition useful as a fungicide. The composition can be used alone or in combination with other pesticides/fungicides for example for enhancing the effect of said other pesticide/fungicide.

### BACKGROUND OF INVENTION

A biocide is a chemical substance or microorganism which can deter, render harmless, or exert a controlling effect on any harmful organism by chemical or biological means. Biocides are commonly used in medicine, agriculture, forestry, and industry. Pesticidesis a species of the genus biocide and includes substances intended for attracting, seducing, destroying, or mitigating pest. The most common use of pesticides today is as plant protection products (also known as crop protection products), which in general protect plants from damaging influences such as weeds, plant diseases or insects. This use of pesticides is so common that the term pesticide is often treated as synonymous with plant protection product, although it is in fact a broader term, as pesticides are also used for non-agricultural purposes.

The genus pesticide can be subdivided into the species herbicide, insecticide, insect growth regulator, nematicide, termiticide, molluscicide, piscicide, avicide, rodenticide, predacide, bactericide, insect repellent, animal repellent, antimicrobial, fungicide, disinfectant (antimicrobial), and sanitizer, depending on the particular composition and its use.

Fungicides are biocidal chemical compounds or biological organisms used to kill or inhibit growth of fungi or fungal spores. Fungi can cause serious damage in agriculture, resulting in critical losses of yield, quality, and profit. Fungicides are used both in agriculture and to fight fungal infections in animals. Chemicals used to control oomycetes, which are not fungi, are also referred to as fungicides as oomycetes use the same mechanisms as fungi to infect plants.

Fungicides can either be contact, translaminar or systemic. Contact fungicides are not taken up into the plant tissue, and protect only the plant locally where deposited while translaminar fungicides redistribute the fungicide from the upper, treated leaf surface to the lower unsprayed surface. Systemic fungicides are taken up into the plant and redistributed through the xylem vessels.

Fungicides thus serve as an important means for effective management of many serious plant diseases. The indiscriminate use of pesticides such as fungicides has however resulted in the development of resistance to several pathogens. Development of resistance to fungicides has thus become a serious concern in the management of crop diseases and has reduced or eliminated potency of some originally highly effective commercial fungicides. This has led to poor disease control in many instances (Thind, Tarlochan S., ed. Fungicide resistance in crop protection: risk and management. CABI, 2012). Additionally, many commercially available fungicides have serious implications for the environment. There is thus a need for development of environmentally acceptable fungicides with novel modes of action in order to ensure appropriate disease control in the agricultural field.

### SUMMARY OF INVENTION

The present inventors have surprisingly found that a composition comprising a combination of two biocides having synergistic antifungal effect thus minimizing the effective concentration required. Use of a 2 component biocidal composition may also reduce the risk that the targeted fungus develops resistance towards the biocide composition. The inventors have also surprisingly found that the composition is particularly useful for treating or preventing microbial infections in plants.

The inventors of the present invention have furthermore surprisingly succeeded in providing stable fungicide compositions comprising a combination of the biocides and one or more known pesticides, wherein the composition has a synergistic effect.

The biocidal composition according to the invention has many different uses, one of which is as a pesticide composition. Other non-limiting uses for a biocidal composition according to the invention is e.g. in:
Fungicide for control of Septoria spp. (e.g. S. tritici) such as in wheat (e.g. winter wheat)
Fungicide for control of Fusarium spp. (e.g. F. culmorum) such as in wheat (e.g. winter wheat)
Fungicide for control of Puccinia spp. (e.g. P. striiformis),
Fungicide for control of Blumeria spp. (e.g. B. graminis).

In another embodiment the present invention relates to a method of enhancing the pesticide effect of a known pesticide, such as Bumper 250 EC, by mixing with one or more one or more biocidal compounds. The composition is preferably for controlling fungi in crop fields or greenhouses.

The composition is furthermore preferably a liquid pesticide, and may comprise one or more biocidal compounds selected from the group consisting of a PQ polymer, Poly(hexamethylenebiguanide) hydrochloride, Akacid Forte®, Akacid®, N,N-didecyl-N-methyl-poly(oxyethyl) ammonium propionate (Bardap-26), povidone-iodine (PVP-iodine, Betadine™); benzyl C₁₂₋₁₈-alkyldimethyl ammonium chlorides, benzyl C₁₂₋₁₄-alkyldimethyl ammonium chlorides, C₁₂₋₁₃-alkyl[(ethylphenyl)methyl]dimethyl ammonium chlorides (ADBAC), di-C₈₋₁₀alkyldimethyl ammonium chloride (DDAC), and Octenidine dihydrochloride; or toxicological acceptable salts or solvates thereof.

In another preferred embodiment of the invention the one or more biocidal compounds is a synergistic combination which may be used as such or as part of a composition also comprising one or more known pesticides.

In one preferred embodiment of the invention the one or more biocidal compounds and/or one or more known pesticides is a synergistical combination providing an increased biocidal effect compared to use of either compound alone in same total concentration. In an especially preferred embodiment of the invention the biocidal compound is selected from azoles, prothioconazole (e.g. Bumper 250 EC), propiconazole, tebuconazole, metconazole, mancozeb (e.g. Dithane NT), folpet (MCW 296 SC), epoxiconazole (E.g. Rubic), azoxystrobin, and combinations thereof.

### DESCRIPTION OF DRAWINGS

FIG. 1: Effect on Stripe (yellow) rust, caused by Puccinia striiformis f. sp. tritici (Pst). The figure show the effect of reference control Tebuconazole regarding the growth of pathogen Stripe (yellow) rust. As demonstrated the Tebuconazole is able to eliminate the fungi attack both in a preventive and a curative manner.

FIG. 2: Effect on Stripe (yellow) rust, caused by Puccinia striiformis f. sp. tritici (Pst). The figure show the effect of biocide B regarding the growth of pathogen Stripe (yellow) rust. As demonstrated the biocide A is able to eliminate the fungi attack both in a preventive and a curative manner.

FIG. 3:

Effect on Stripe (yellow) rust, caused by Puccinia striiformis f. sp. tritici (Pst). The figure show the effect of biocide A regarding the growth of pathogen Stripe (yellow) rust. As demonstrated the biocide A have a less effect on the fungi growth both in a preventive and a curative manner.

FIG. 4: The effect on septoria growth using different fungicides. Rubric and Folpet provided best control of septoria, and the biocide B at 100 ppm provided control in line with Bumper 250 EC.

FIG. 5: The figure demonstrates that the yield levels in winter wheat at Flakkebjerg, various fungicides. The effects of the biocides were moderate to high (75-96 dt/ha) and increases from treatments were positive and significantly different from untreated. The low dose of the biocide B provided yields in line with Bumper 250 EC, indicating that the product has a potential for providing moderate control of septoria

FIG. 6: The figure shows the effect of biocide composition comprising comprises equimolar amounts of polyhexamethyleneguanidine hydrochloride (Akacide forte) and N,N-didecyl-N-methyl-poly(oxyethyl) ammonium propionate (Bardap 26) in combination with azols, propiconazole or prothioconazole on wheat pathogens.

FIG. 7: The figure shows the effect of biocide composition comprising comprises equimolar amounts of polyhexamethyleneguanidine hydrochloride (Akacide forte) and N,N-didecyl-N-methyl-poly(oxyethyl) ammonium propionate (Bardap 26) in combination with azols, propiconazole or prothioconazole on potato Alternaria pathogens

FIG. 8: The figure shows the effect of a biocide composition comprising comprises equimolar amounts of polyhexamethyleneguanidine hydrochloride (Akacide forte) and

N,N-didecyl-N-methyl-poly(oxyethyl) ammonium propionate (Bardap 26) on yield increase, used as enhancer in Bumper 250 EC as a reference product. The data demonstate a 45% yield increase in using the biocide composition as enhancer, compared to Bumper 250 EC alone.

### DETAILED DESCRIPTION OF THE INVENTION

Plants such as agricultural crops are frequently infected by microorganisms, such as fungi, which causes great economic losses to for the agricultural and forestry sector. Serious pathogens of many cultivated plants causing extensive damage and losses to agriculture and forestry include the rice blast fungus Magnaporthe oryzae, tree pathogens such as Ophiostoma ulmi and Ophiostoma novo-ulmi causing Dutch elm disease, and Cryphonectria parasitica responsible for chestnut blight, and plant pathogens in the genera Fusarium, Ustilago, Alternaria, and Cochliobolus.

It is a main aspect of the invention to provide a composition for use in the treatment of microbial infections in plants. It is also a main object to provide a composition for use in the treatment fungi in particular treatment or prevention of fungi in plants. Non-limiting uses for a biocidal composition according to the invention is e.g. in:
Fungicide for control of Septoria spp. (e.g. S. tritici) such as in wheat (e.g. winter wheat)
Fungicide for control of Fusarium spp. (e.g. F. culmorum) such as in wheat (e.g. winter wheat)
Fungicide for control of Puccinia spp. (e.g. P. striiformis),
Fungicide for control of Blumeria spp. (e.g. B. graminis).
Fungicide for treatment of crops such as potato, soy beans, coffee, and various kinds of fruit.

The terms “biocide” or “biocidal compound”, as used herein, are intended to mean a compound that eliminates or significantly reduces the growth of microorganisms. The terms may be used interchangeably herein and includes, unless otherwise stated, antimicrobial compounds, such as e.g. germicides, antibiotics, antibacterials, antivirals, antifungals, antiprotozoals and antiparasites. The microorganisms to be effected by these compounds may preferably be bacteria, vira or fungi; more preferably bacteria and fungi. It is an object of the present invention to provide a pesticide that may eliminate or significantly reduce the growth of microorganisms selected from the group consisting of bacteria (such as e.g. Streptococcus, Gardnerella, Staphylococcus aureus, Escherichia coli, bacteriods, or mycoplasma), fungi (such as e.g. Candida albicans), and vira (such as e.g. HIV-1, Hepatitis B or Hepatitis C). The biocidal effect of a pesticide according to the present invention may for instance be assayed against a group of representative microorganisms such as e.g. Septoria spp. (e.g. S. tritici), Fusarium spp. (e.g. F. culmorum), Puccinia spp. (e.g. P. striiformis), Blumeria spp. (e.g. B. graminis), Staphylococcus aureus, Escherichia coli, and Candida albicans.

The terms “pesticide” or “known pesticide”, as used herein, are intended to mean substances meant for attracting, seducing, destroying, or mitigating any pest. Pesticides are a class of biocides. The most common use of pesticides is as plant protection products (also known as crop protection products), which in general protect plants from damaging influences such as weeds, plant diseases or insects. This use of pesticides is so common that the term pesticide is often treated as synonymous with plant protection product, although it is in fact a broader term, as pesticides are also used for non-agricultural purposes. The term pesticide includes all of the following: herbicide, insecticide, insect growth regulator, nematicide, termiticide, molluscicide, piscicide, avicide, rodenticide, predacide, bactericide, insect repellent, animal repellent, antimicrobial, fungicide, disinfectant (antimicrobial), and sanitizer.

The terms “pesticide effect” or “pesticide action” or “pesticide activity”, as used herein, are intended to mean the beneficial effect of a pesticide measured by e.g. controlling or reducing a pest, weed, plant disease or insect thereby improving the crop yields or control the invasive species.

The term “fungicide”, as used herein, is intended to mean a biocidal chemical compounds or biological organisms used to kill or inhibit fungi or fungal spores or fungal development in general. Chemicals used to control oomycetes, which are not fungi, are also referred to as fungicides as oomycetes use the same mechanisms as fungi to infect plants. Fungicides can either be contact, translaminar or systemic. Contact fungicides are not taken up into the plant tissue, and protect only the plant where the spray is deposited; translaminar fungicides redistribute the fungicide from the upper, sprayed leaf surface to the lower, unsprayed surface; systemic fungicides are taken up and redistributed through the xylem vessels. Few fungicides move to all parts of a plant. Some are locally systemic, and some move upwardly. Most fungicides that can be bought retail are sold in a liquid form.

The term “surfactant”, as used herein, is intended to mean compounds that lower the surface tension (or interfacial tension) between two liquids or between a liquid and a solid. Surfactants may act as detergents, wetting agents, emulsifiers, foaming agents, and dispersants.

The term “curative effect”, as used herein, is intended to mean a treatment that cures a plant disease such as an infection caused by microorganism including fungi, bacteria and virus infections or diseases.

The term “preventive effect”, as used herein, is intended to mean a treatment that prevents or reduce a plant disease such as an infection caused by microorganism including fungi, bacteria or virus.

In a main aspect, a use is provided herein of a composition as defined herein comprising polyhexamethyleneguanidine hydrochloride and N,N-didecyl-N-methyl-poly(oxyethyl) ammonium propionate for treating or preventing a microbial infection in a plant. The microbial infection is preferably as explained elsewhere herein with phytopathogenic fungi.

In another aspect, a use of polyhexamethyleneguanidine hydrochloride and N,N-didecyl-N-methyl-poly(oxyethyl) ammonium propionate is provided as a plant protection formula. In particular, a use is provided of a composition comprising polyhexamethyleneguanidine hydrochloride and N,N-didecyl-N-methyl-poly(oxyethyl) ammonium propionate as a plant protection formula, where the composition may comprise one or more further components as defined herein below.

One aspect also relates to a plant protection formula comprising polyhexamethyleneguanidine hydrochloride and N,N-didecyl-N-methyl-poly(oxyethyl) ammonium propionate. The plant protection formula may comprise one or more further agents, such as emulsifiers, surfactants, pesticides etc. as described herein below.

Another aspect relates to a method for for treating or preventing a microbial infection in plants, said method comprising the steps of: a) providing at least one composition as defined herein comprising polyhexamethyleneguanidine hydrochloride and N,N-didecyl-N-methyl-poly(oxyethyl) ammonium propionate, and b) applying an agriculturally effective amount thereof to the plants. The composition may be provided to at least one of the following: the plant, plant foliage, blossoms, stems, fruits, the area adjacent to the plant, soil, seeds, germinating seeds, roots, liquid and solid growth media, and hydroponic growth solutions.

One aspect also relates to a method of controlling plant diseases caused by oomycete fungal pathogens including the steps of:
a) providing a composition as defined herein comprising polyhexamethyleneguanidine hydrochloride and N,N-didecyl-N-methyl-poly(oxyethyl) ammonium propionate, and
b) applying an agriculturally effective amount of the formulation to at least one of the following: the plant, plant foliage, blossoms, stems, fruits, the area adjacent to the plant, soil, seeds, germinating seeds, roots, liquid and solid growth media, and hydroponic growth solutions.

Another aspect relates to a method for controlling pathogens in a crop, comprising the steps of:
a. Providing a composition as defined herein comprising polyhexamethyleneguanidine hydrochloride and N,N-didecyl-N-methyl-poly(oxyethyl) ammonium propionate, and
b. administering the composition to the crop.

### Active Components

The biocidal composition provided herein is preferably a plant protection component (PPC) or a plant protection formula (PPF) and the composition comprises polyhexamethyleneguanidine hydrochloride and N,N-didecyl-N-methyl-poly(oxyethyl) ammonium propionate. Thus, the composition provided for use herein for treating or preventing a microbial infection in a plant is a mixture of
a) polyhexamethyleneguanidine hydrochloride and
b) N,N-didecyl-N-methyl-poly(oxyethyl) ammonium propionate.

Polyhexamethyleneguanidine hydrochloride has the CAS number: 57028-96-3. Polyhexamethyleneguanidine hydrochloride is the active ingredient in Akacid Forte and the molar weight of the active ingredient (CAS nr. 57028-96-3) in Akacid Forte is about 1000 g/mol.

N,N-didecyl-N-methyl-poly(oxyethyl) ammonium propionate has the CAS number 94667-33-1. N,N-didecyl-N-methyl-poly(oxyethyl) ammonium propionate is the active ingredient in Bardap-26 and the molar weight of the active ingredient (CAS nr. 94667-33-1) in Bardap-26 is about 454 g/mol.

The amount of polyhexamethyleneguanidine hydrochloride in the composition for use in treatment or prevention of specific microbial infections and/or for use in specific plants can be determined by the skilled person. However, the concentration of polyhexamethyleneguanidine hydrochloride is preferably in the range from 0.05 to 6000 ppm. More preferred, the concentration of polyhexamethyleneguanidine hydrochloride is in the range from 0.5 to 600 ppm, such as in the range from 5 to 60 ppm

Similarly, the amount of N,N-didecyl-N-methyl-poly(oxyethyl) ammonium propionate in the composition for use in treatment or prevention of specific microbial infections and/or for use in specific plants can be determined by the skilled person. However, the concentration of N,N-didecyl-N-methyl-poly(oxyethyl) ammonium propionate is preferably in the range from 0.05 to 6000 ppm. More preferred, the concentration of N,N-didecyl-N-methyl-poly(oxyethyl) ammonium propionate is in the range from 0.5 to 600 ppm, such as in the range from 5 to 60 ppm.

For some plants and crops, the concentration of the active components, polyhexamethyleneguanidine hydrochloride and N,N-didecyl-N-methyl-poly(oxyethyl) ammonium propionate, may influence the effect of the biocide composition. In particular, excessive use of high concentration biocides may neutralize or even counteract the positive effect of the biocide in terms of plant protection, yield increase, crop quality etc. Thus, depending on the plant and/or microorganism targeted, the optimal concentration of the biocides should be determined. In many cases, it is preferred that the concentration is below 100 ppm, such as between 2-60 ppm, for example when treating red cabbage, the concentration should preferably be lower than 100 ppm, and preferably around 50 ppm, such as between 25 and 75, or even range between 40 and 60 ppm.

The ratio between polyhexamethyleneguanidine hydrochloride and N,N-didecyl-N-methyl-poly(oxyethyl) ammonium propionate may also depend on the specific use of the composition. However, in general, the molar ratio of polyhexamethyleneguanidine hydrochloride and N,N-didecyl-N-methyl-poly(oxyethyl) ammonium propionate is from 1:100 to 100:1. More preferred, the molar ratio of polyhexamethyleneguanidine hydrochloride and N,N-didecyl-N-methyl-poly(oxyethyl) ammonium propionate is from 1:10 to 10:1, such as from 1:5 to 5:1, such as from 1:2 to 2:1. Even more specifically, the molar ratio of polyhexamethyleneguanidine hydrochloride and N,N-didecyl-N-methyl-poly(oxyethyl) ammonium propionate is 1.27:1, or even 1:1, i.e. polyhexamethyleneguanidine hydrochloride and N,N-didecyl-N-methyl-poly(oxyethyl) ammonium propionate is present in equimolar amounts in the composition used for treating or preventing a microbial infection, such as a fungal infection, in a plant.

Nevertheless, the molar concentration of polyhexamethyleneguanidine hydrochloride may be higher than the molar concentration of N,N-didecyl-N-methyl-poly(oxyethyl) ammonium propionate. However, the molar concentration of polyhexamethyleneguanidine hydrochloride may also be lower than the molar concentration of N,N-didecyl-N-methyl-poly(oxyethyl) ammonium propionate.

### Plants

The plant protection biocidal compositions provided herein can be used for treating or preventing a microbial infection in any type of plant. For example, the composition can be used for for treating or preventing a microbial infection in harvested fruit, cutflowers or vegetables; i.e. for protection of harvested fruit, cutflowers or vegetables.

The fruit and vegetable may be selected from cereals, e.g. wheat, barley, rye, oats, rice, sorghum and the like; beets, e.g. sugar beet and fodder beet; pome and stone fruit and berries, e.g. apples, pears, plums, peaches, almonds, cherries, strawberries, raspberries and blackberries; leguminous plants, e.g. beans, lentils, peas, soy beans; oleaginous plants, e.g. rape, mustard, poppy, olive, sunflower, coconut, castor-oil plant, cocoa, ground-nuts; cucurbitaceae, e.g. pumpkins, gherkins, melons, cucumbers, squashes; fibrous plants, e.g. cotton, flax, hemp, jute; citrus fruit, e.g. orange, lemon, grape-fruit, mandarin; tropical fruit, e.g. papaya, passion fruit, mango, carambola, pineapple, banana; vegetables, e.g. spinach, lettuce, asparagus, brassicaceae such as cabbages and turnips, carrots, onions, tomatoes, potatoes, hot and sweet peppers; laurel-like plants, e.g. avocado, cinnamon, camphor tree; or plants such as maize, tobacco, nuts, coffee, sugar-cane, tea, grapevines, hops, rubber plants, as well as ornamental plants, e.g. cutflowers, roses, gerbera and flower bulbs, shrubs, deciduous trees and evergreen trees such as conifers.

In another embodiment, the fruit and/or vegetable is selected from pome and stone fruit and berries, in particular apples, pears, plums, peaches, almonds, cherries, strawberries, raspberries and blackberries, citrus fruit, in particular orange, lemon, grapefruit, mandarin, tropical fruit, in particular papaya, passion fruit, mango, carambola, pineapple, banana and grapevines. In another embodiment, the plant is a grape, potato, tomato, cucumber, squash or other cucurbits, cabbage or other crucifer, lettuce, beans, corn, soybeans, pepper or hops.

The composition is preferably for treating or preventing a microbial infection in soy, wheat, potato and/or red cabbage.

### Microbial Infections

In one preferred embodiment, the composition is provided for use in for treating or preventing a microbial infection. The plant protection biocidal compositions provided herein display a broad-spectrum antimicrobial activity. Thus, the composition can be used for treating or preventing any microbial infection in plants. The composition is however, in one preferred embodiment provided for treating or preventing a microbial infection with phytopathogenic fungi. The fungi may be selected from the group consisting of Phytophthora infestans, Plasmopara viticola, Phytophthora capsici, Pseudoperonospora cubensis, Bremia lactucae, Phytophthora phaseoli, Phytophthora nicotiane var. parasitica, Sclerospora graminicola, Sclerophthora rayssiae, Phytophthora palmivora, Phytophthora citrophora, Sclerophthora macrospora, Sclerophthora graminicola, Phytophthora cactorum, Phytophthora syringe, Pseudoperonospora humuli, and Albugo Candida.

In another embodiment, the composition is for use in for treating or preventing a plant disease caused by a fungi selected from the group consisting of Colletotrichum spp., e.g. Colletotrichum musae, Colletotrichum gloeosporioides, Colleto-trichum coccodes; Fusarium spp., e.g. Fusarium semitectum, Fusarium moniliforme, Fusa-rium solani, Fusarium oxysporum; Verticillium spp., e.g. Verticillium theobromae; Nigro-spora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Alternaria spp., e.g. Alternaria citri, Alternaria altemata; Phytophthora spp., e.g. Phytophthora citrophthora, Phy-tophthora fragariae, Phytophthora cactorum, Phytophthora parasitica; Septoria spp., e.g. Sep-toria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporium spp., e.g. Gloeosporium album, Gloeosporium perennans, Gloeospo-rium fructigenum, Gloeosporium singulata; Phlyctaena spp., e.g. Phlyctaena vagabunda; Cyl-indrocarpon spp., e.g. Cylindrocarpon mali; Stemphyllium spp., e.g. Stemphyllium vesi-carium; Phacydiopycnis spp., e.g. Phacydiopycnis malirum; Thielaviopsis spp., e.g. Thielav-iopsis paradoxy; Aspergillus spp., e.g. Aspergillus niger, Aspergillus carbonarius; Nectria spp., e.g. Nectria galligena; Pezicula spp.

In another embodiment, the fungi is selected from the kingdom of Fungi, such as from the subkingdom of Dikarya, such as from the phylum Ascomycota, such as from the subphylum Pezizomycotina, such as from the class Sordariomycetes, such as from the order Hypocreales, such as from the family Nectriaceae, such as from the genus Fusarium, such as a species selected from the group consisting of F. avenaceum, F. culmorum, F. graminearum, F. langsethiae, F. oxysporum, F. poae, F. sporotrichioides, F. tricinctum, F. verticillioides, and F. virguliforme.

In one more specific embodiment, the composition is provided for use in treating or preventing a microbial infection with Fusarium ssp, such as F. culmorum and/or F. graminearum; and/or Septoria ssp, such as Zymoseptoria tritici; for example in wheat.

In another specific embodiment, the composition is provided for use in treating or preventing a microbial infection with Alternaria ssp, such as A. alternata and/or A. solani; for example for such use in potato.

### Surfactants

The composition provided for use herein for treating or preventing a microbial infection in plants may comprise one or more additional components as is also described elsewhere herein. For example, the composition may comprise a surfactant, as an example, the composition may comprise one or more surfactants selected from the group consisting of non-ionic surfactants and monovalent cationic surfactants.

A non-ionic surfactants may be described by the general formula (I):

R2-R1(OCH2CH2)xOH,

wherein R1 is a C7-20-alkyl, R2 is an optional substituent, and x is an integer between 2 and 12. In one embodiment, R1 is selected from the group consisting of alkyl, C3-8-cycloalkyl, C3-8-cycloalkyl-C1-6-alkyl, C1-6-alkyl-C3-8-cycloalkyl, aryl-C1-6-alkyl, C1-6-alkyl-aryl, aryl-C1-6-alkyl, C1-6-alkyl-oxy, C3-8-cycloalkyl-oxy, C3-8-cycloalkyl-C1-6-alkyl-oxy, C3-8-cycloalkyl-oxy-C1-6-alkyl, C1-6-alkyl-oxy-C3-8-cycloalkyl, C1-6-alkyl-C3-8-cycloalkyl-oxy, aryl-C1-6-alkyl-oxy and aryl.

In another embodiment, R1 is selected from the group consisting of C7-20-alkyl-(OCH2CH2)yOH and C7-20-alkyl-(OCH2CH2)zOH wherein y and z individually are selected from integers between 2 and 12. In one embodiment it is provided that when R is a C18-alkyl then the surfactant does not comprise an alkoxylated moiety that comprises higher alkoxides than the ethylene oxides.

In one preferred embodiment, x is an integer between 4 and 8. In another embodiment, R1 is a C12-14-alkyl.

In one embodiment, R2 is selected from the group consisting of C1-6-alk (en/yn)yl, C3-8-cycloalk(en)yl, C3-8-cycloalk(en)yl-C1-6-alk(en/yn)yl, CI-6-alk(en/yn)yl-C3-8-cycloalk(en)yl, aryl-CI-6-alk (en/yn)yl, CI-6-alk (en/yn)yl-aryl, aryl-CI-6-alk (en/yn)yl, CI-6-alk (en/yn)yl-oxy, C3-8-cycloalk(en)yl-oxy, C3-8-cycloalk(en)yl-CI-6-alk(en/yn)yl-oxy, C3-8-cycloalk(en)yl-oxy-CI-6-alk(en/yn)yl, CI-6-alk(en/yn)yl-oxy-C3-8-cycloalk(en)yl, CI-6-alk(en/yn)yl-03-8-cycloalk(en)yl-oxy, aryl-CI-6-alk (en/yn)yl-oxy and aryl-oxy-CI-6-alk (en/yn)yl and aryl.

The nonionic surfactant can also be an alkoxylated nonionic surfactant.

The one or more surfactants may also be selected from the group consisting of a C12-14 alcohol polyethylene glycol ether mixture and iso-C12-14 alcohol ethoxylates such as iso-C13 alcohol ethoxylate and combinations thereof. For example, the iso-C12-14 alcohol ethoxylate is iso-C13 alcohol ethoxylate.

The composition may also comprise a C12-14 alcohol polyethylene glycol ether mixture, for example the C12-14 alcohol polyethylene glycol ether mixture is a mixture between fatty alcohols with 9 mol ethylene oxide and fatty alcohols with 3 mol ethylene oxide. In another embodiment, the composition comprises a single surfactant which is an iso-C12-14 alcohol ethoxylates, for example, the iso-C12-14 alcohol ethoxylates is iso-C13 alcohol ethoxylate.

### Further Components

In addition to surfactants, other components could also be combined with polyhexamethyleneguanidine hydrochloride and N,N-didecyl-N-methyl-poly(oxyethyl) ammonium propionate with or without a surfactant to obtain a composition for use in treating or preventing a plant microbial infection. The additional components are chosen in order to optimize specific characteristics of the composition, such as its biocidal effects or physical properties.

In one embodiment, the composition comprises one or more chelating agent, such as a chelating agent selected from the group consisting of Aminotri(methylene phosponic acid)penta sodium salt, methylglycinediacetic acid, Potassium tripolyphosphate, and combinations thereof; such as methylglycinediacetic acid e.g. as the trisodium salt or other toxicological acceptable salts or solvates thereof.

In another embodiment, the composition comprises a further pesticide, such as a further fungicide and/or insecticide. Such a further pesticide or fungicide could be selected from the group consisting of azoles, prothioconazole (e.g. Bumper 250 EC), propiconazole, tebuconazole, metconazole, mancozeb (e.g. Dithane NT), folpet (MCW 296 SC), epoxiconazole (E.g. Rubic), azoxystrobin, and combinations thereof. It is preferred that the pesticidal and/or fungicidal activity of the further pesticide or fungicide is enhanced, when used in composition provided herein. In a specifically preferred embodiment, the composition further comprises prothioconazole or propiconazole, for example the composition also comprises prothioconazole, such as Bumper 250 EC.

The concentration of the further pesticide or fungicide or insecticide is determined for each specific compound used; in general the concentration of a further pesticide or fungicide could range from 0.01 to 6000 ppm, such as from 1 to 600 ppm, such as from 10 to 60 ppm.

The further pesticide or fungicide may also be selected from the group consisting of:

(a) trifloxystrobin, fluoxastrobin, kresoxim-methyl, metominostrobin, orysastrobin, enestrobin and fenamidone, and salts thereof,
(b) bitertanol, bromuconazole, cyproconazole, difenoconazole, epoxiconazole, fenbu-conazole, fenpropidin, fenpropimorph, fluquinconazole, flusilazole, flutriafol, metconazole, penconazole, propiconazole, prothioconazole, spiroxamine, tebuconazole, triadimefon, triadimenol, and salts thereof,
(c) bixafen [N-{3′,4′-dichloro-5-fluoro-I,I′-biphenyl-2-yl)-3-(difluoromethyl)-I-methyl-IH-pyrazole-4-carboxamide], carboxin, 3-(difluoromethyl)-I-methyl-N-[I,2,3,4-tetrahydro-9-(I-methylethyl)-I,4-methanonaphthalen-5-yl]-IH-pyrazole-4-carboxamide (isopyra-zam), fluopicolide, fluopyram [(N-{2-[3-chloro-5-(trifluoromethyl)pyridin-2-yl]ethyl}-2-(trifluoromethyl)benzamide)], flutolanil, furametpyr, penthiopyrad, thifluzamide, N-[2-(I,3-dimethylbutyl)phenyl]-5-fluoro-I,3-dimethyl-IH-pyrazole-4-carboxamide, N-{2-[I,r-bi(cyclopropyl)-2-yl]phenyl}-3-(difluoromethyl)-I-methyl-IH-pyrazole-4-car-boxamide, I-methyl-N-[2-(I,I,2,2-tetrafluoroethoxy)phenyl]-3-(trifluoromethyl)-IH-pyrazole-4-carboxamide, 2-chloro-N-[4′-(3,3-dimethylbut-I-yn-I-yl)biphenyl-2-yl]-pyridine-3-carboxamide, 3-(difluoromethyl)-I-methyl-N-[2-(I,I,2,2-tetrafluoroethoxy)-phenyl]-IH-pyrazolê-carboxamide, 3-(difluoromethyl)-N-[(9R)-9-isopropyl-I,2,3,4-tetrahydro-1,4-methanonaphthalen-5-yl]-I-methyl-IH-pyrazole-4-carboxamide, 3-(di-fluoromethyl)-N-[(9S)-9-isopropyl-I,2,3,4-tetrahydro-I,4-methanonaphthalen-5-yl]-I-methyl-1H-pyrazolêt-carboxamide, 3-(difluoromethyl)-N-[4′-(3,3-dimethylbut-1-yn-1-yl)biphenyl-2-yl]-I-methyl-IH-pyrazole-4-carboxamide and salts thereof,
(d) cyprodinil, mepanipyrim, fluazinam, and salts thereof,
(e) fosetyl-Al, iprodione, propineb, tolylfluanid and salts thereof.

In addition, a further fungicide may be selected from the group consisting of mancozeb, maneb, zineb, thiram, propineb, metiram, copper hydroxide, copper oxychloride, Bordeaux mixture, captan, folpet, amisulbrom, azoxystrobin, trifloxystrobin, picoxystrobin, kresoxim-methyl, fluoxastrobin, pyraclostrobin, famoxadone, fenamidone, metalaxyl, mefenoxam, benalaxyl, cymoxanil, propamocarb, dimethomorph, flumorph, mandipropamid, iprovalicarb, benthiavalicarb-isopropyl, valiphenal, zoxamide, ethaboxam, cyazofamid, fluopicolide, fluazinam, chlorothalonil, dithianon, tolylfluanid, 4-fluorophenyl (IS)-I-({[(IR,S)-(4-cyanophenyl)ethyl] sulfonyl} methyl)propylcarbamate.

In one specific embodiment, the composition further comprises one or more chloronitriles, strobilurins, and/or triazoles.

The composition provided for use treating or preventing a plant microbial infection may also comprise one or more emulsifiers. In a preferred use, the composition comprises one or more emulsifiers in an amount of 0.01-5%, such as 0.01-0.5, such as around 0.15%.

In a preferred embodiment, the composition comprises the commercially available emulsifier, Kantor, which consists of 79% of alkoxylated triglyceride. The contents of Kantor are shown below.

TABLE
Kantor; components of Kantor shown in percentages

| 1-<5 | Alkylpolyglycosid C8-10 |
|---|---|
| | CAS: 68515-73-1, EINECS/ELINCS: Polymer |
| | GHS/CLP: Eye Dam. 1: H318 |
| | EEC: Xi, R 41 |
| 1-<3 | Essigsäure |
| | CAS: 64-19-7, EINECS/ELINCS: 200-580-7, EU-INDEX: |
| | 607-002-00-6 |
| | GHS/CLP: Flam. Liq. 3: H226 - Skin Corr. 1A: H314 |
| | EEC: C, R 10-35 |

### Composition

The composition provided herein for use in treating or preventing a microbial infection in a plant can be provided as ready-to-use aerosol liquor. However, the composition can also be a concentrate composition, for example a concentrate, which must the diluted 100.000, 10.000, 1.000 or 100 times.

In addition, one aspect herein relates to a composition, which comprises polyhexamethyleneguanidine hydrochloride and N,N-didecyl-N-methyl-poly(oxyethyl) ammonium propionate and a further pesticide or fungicide. Relevant further pesticides or fungicides are also mentioned herein above, and in one preferred embodiment, the further pesticide or fungicide is selected from the group consisting of azoles, prothioconazole (e.g. Bumper 250 EC), propiconazole, tebuconazole, metconazole, mancozeb (e.g. Dithane NT), folpet (MCW 296 SC), epoxiconazole (E.g. Rubic), azoxystrobin, and combinations thereof.

In one aspect, a plant protection formula is provided, which comprises polyhexamethyleneguanidine hydrochloride and N,N-didecyl-N-methyl-poly(oxyethyl) ammonium propionate. Preferred embodiments include plant protection formulas, which comprise a composition as defined elsewhere herein, in particular with respect to the relative amounts of polyhexamethyleneguanidine hydrochloride and N,N-didecyl-N-methyl-poly(oxyethyl) ammonium propionate, further components, such as surfactants and more.

### Preparation of Composition

The active components of the composition provided herein may be combined in any relevant amounts, which together are active as biocides in plants.

In a preferred embodiment, the two active compounds, polyhexamethyleneguanidine hydrochloride and N,N-didecyl-N-methyl-poly(oxyethyl) ammonium propionate, are added as equivalent molecular amount. The volume of each compound to mix can be calculated on the basis of their molecular weight and the concentration of each compound in a solution.

For example, a 40% solution of polyhexamethyleneguanidine hydrochloride (e.g. Akacide forte) and a 70% solution of N,N-didecyl-N-methyl-poly(oxyethyl) ammonium propionate (e.g. Bardap 26) can be mixed in order to obtain equimolar amounts as 793 ml hydrochloride (e.g. Akacide forte) with 207 ml N,N-didecyl-N-methyl-poly(oxyethyl) ammonium propionate (e.g. Bardap 26) in order to obtain 1 litre of a biocide composition of the present invention.

### EXAMPLES

### Example 1: Preparation of Biocide Compositions

Compositions comprising biocides A and B respectively, were prepared by mixing ingredients as outlined in tables 1A and 1B below.

TABLE 1A
Biocide A composition (incl. detergent):

| Ingredient | Amount % (w/w) |
|---|---|
| Water | 69.5% |
| Propylene glycol | 5% |
| Trilon ® M | 3% |
| Lutensol TO 89 | 12.5% |
| (90% (w/w) isotridecanolethoxylat, polymer | |
| (CAS nr. 69011-36-5)) | |
| Bardap-26 comprising 70% | 5 (3.5% CAS |
| CAS 94667-33-1 * | 94667-33-1) |
| Akacid Forte comprising 25% | 5 (1.25% CAS |
| CAS 57028-96-3 ** | 57028-96-3) |

* A content of 5% (w/w) Bardap-26 comprising 70% CAS 94667-33-1 in each of detergents A, B and C gives a content of 3.5% (w/w) CAS 94667-33-1, which is the active ingredient in Bardap-26.
** A content of 5% (w/w) Akacid Forte comprising 25% CAS 57028-96-3 in each of detergents A, B and C gives a content of 1.25% (w/w) CAS 57028-96-3, which is the active ingredient in Akacid Forte.

TABLE 1B
Biocide B composition (without detergent):

| Ingredient | Amount % (w/w) |
|---|---|
| Bardap-26 comprising | 50% (35% CAS |
| 70% CAS 94667-33-1 | 94667-33-1) |
| Akacid Forte comprising | 50% (12.5% CAS |
| 25% CAS 57028-96-3 | 57028-96-3) |

The molar ratio of CAS 94667-33-1 and CAS 57028-96-3 in Biocide B is around 1.27 to 1 (1.27:1).

### Example 2: In Vitro Effect on Fusarium (Spore Growth)

Sensitivity towards Tebuconazole (control) and Biocides A and B (see tables 1A and 1B) respectively, was tested in petri dishes using spore suspension containing 2.5×104 spores/ml of each fungal isolate or a mycelium block. 5-6 different concentrations of Biocide A and B respectively, as outlined in table 3 below were used in the tests.

For the tests, the two biocides A and B where individually mixed with potato dextrose broth to achieve the appropriate test concentration. Percent inhibition was assessed after a few days depending on the fungi and its growth rates measured in relation to control. See table 2 below.

TABLE 2
Effect on Fusarium (Spore Growth) in vitro study

| | | |
|---|---|---|
| Biocide A | Biocide B | Tebuconazole |

| Concen- | | Concen- | | Concen- | |
|---|---|---|---|---|---|
| tration | Growth | tration | Growth | tration | Growth |
| (ppm) | (%) | (ppm) | (%) | (ppm) | (%) |
| Positive | 90 | Positive | 90 | Positive | 90 |
| control | | control | | control | |
| 0.6 | 35 | 0.6 | 30 | 0.1 | 25 |
| 6 | 35 | 6 | 0 | 1 | 0 |
| 60 | 20 | 60 | 0 | 3.3 | 0 |
| 600 | 0 | 300 | 0 | 10 | 0 |
| 6000 | 0 | 600 | 0 | 33 | 0 |
| | | | | 100 | 0 |

The table below demonstrates the effect of biocide A and B and reference control Tebuconazole regarding the growth of pathogen Fusarium fungus using agar medium.

### Example 3: In Vitro Effect on Fusarium (Mycelie Growth)

Sensitivity towards Tebuconazole (control) and Biocides A and B (see tables 1A and 1B) respectively, was tested in petri dishes using spore suspension containing 2.5×104 spores/ml of each fungal isolate or a mycelium block. 5-6 different concentrations of Biocide A and B respectively, as outlined in table 3 below were used in the tests.

For the tests, the two biocides A and B where individually mixed with potato dextrose broth to achieve the appropriate test concentration. Percent inhibition was assessed after a few days depending on the fungi and its growth rates measured in relation to control. See table 3 below.

TABLE 3
Effect on Fusarium (Mycelie Growth) in vitro study

| | | |
|---|---|---|
| Biocide A | Biocide B | Tebuconazole |

| Concen- | | Concen- | | Concen- | |
|---|---|---|---|---|---|
| tration | Growth | tration | Growth | tration | Growth |
| (ppm) | (%) | (ppm) | (%) | (ppm) | (%) |
| Positive | 95 | Positive | 95 | Positive | 95 |
| control | | control | | control | |
| 0.6 | 65 | 0.6 | 55 | 0.1 | 10 |
| 6 | 50 | 6 | 25 | 1 | 10 |
| 60 | 45 | 60 | 15 | 3.3 | 0 |
| 600 | 10 | 300 | 0 | 10 | 0 |
| 6000 | 0 | 600 | 0 | 33 | 0 |
| | | | | 100 | 0 |

The table demonstrate the effect of biocide A and B and reference control Tebuconazole regarding the growth of pathogen Fusarium fungus using agar medium. Biocide A (incl. detergent):

### Example 4: In Vitro Effect on Septoria tritici (Mycelie Growth)

Sensitivity towards Tebuconazole (control) and Biocides A and B (see tables 1A and 1B) respectively, was tested in petri dishes using spore suspension containing 2.5×104 spores/ml of each fungal isolate or a mycelium block. 5-6 different concentrations of Biocide A and B respectively, as outlined in table 3 below were used in the tests.

For the tests, the two biocides A and B where individually mixed with potato dextrose broth to achieve the appropriate test concentration. Percent inhibition was assessed after a few days depending on the fungi and its growth rates measured in relation to control. See table 4 below.

TABLE 4
Effect on Septoria tritici (Mycelie Growth) in vitro study

| | | |
|---|---|---|
| Biocide A | Biocide B | Tebuconazole |

| Concen- | | Concen- | | Concen- | |
|---|---|---|---|---|---|
| tration | Growth | tration | Growth | tration | Growth |
| (ppm) | (%) | (ppm) | (%) | (ppm) | (%) |
| Positive | 15 | Positive | 15 | Positive | 15 |
| control | | control | | control | |
| 0.6 | 10 | 0.6 | 0 | 0.1 | 10 |
| 6 | 10 | 6 | 0 | 1 | 5 |
| 60 | 10 | 60 | 0 | 3.3 | 0 |
| 600 | 0 | 300 | 0 | 10 | 0 |
| 6000 | 0 | 600 | 0 | 33 | 0 |
| | | | | 100 | 0 |

The table below demonstrate the effect of biocide A and B and reference control Tebuconazole regarding the growth of pathogen Septoria tritici fungus using agar medium.

### Conclusion

Examples 2, 3 and 4 demonstrate that Biocide B exhibits a clear fungicidal effect against both Fusarium culmorum and Septoria tritici. Furthermore Biocide B has also an effect on both the spore- and mycelial growth on the Septoria tritici fungi. Addition of detergent/soap (biocide A) does not seem to enhance the effect. Surprisingly the detergent containing Biocide composition rather seems to reduce the fungicidal effect. The results furthermore demonstrate a clear dose-response relationship. The effect of biocide B composition was in line with tebuconazole (the best reference product available).

### Example 5: Indoor Greenhouse Study

In this study we used tebuconazole as fungicidal reference (control) and the above outlined biocide A and B compositions for testing the effect on Stripe (yellow) rust, caused by Puccinia striiformis f. sp. tritici (Pst). The applied method also tests preventive and curative effects of the elected fungicide compositions.

The scale used is 0=no attack;

1=necrose with a few pustules;
5=half of the infected leafs are attacked by pustules;
10=100% attack of the leafs.

The leafs were sprayed preventive one day prior to infection with Stripe (yellow) rust. Three days later the plants were sprayed for curative purposes.

16 days later the plant were evaluated.

The following doses were used for both preventive and curative experiments: 30, 100, 300, 1000 ppm

### Conclusion

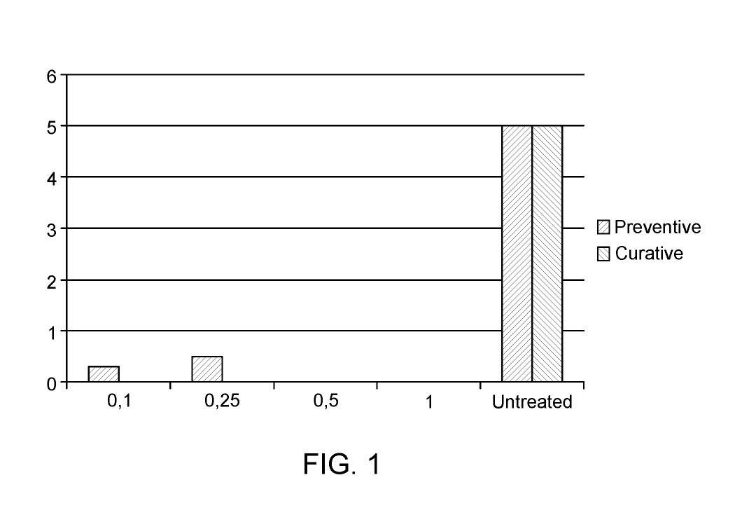

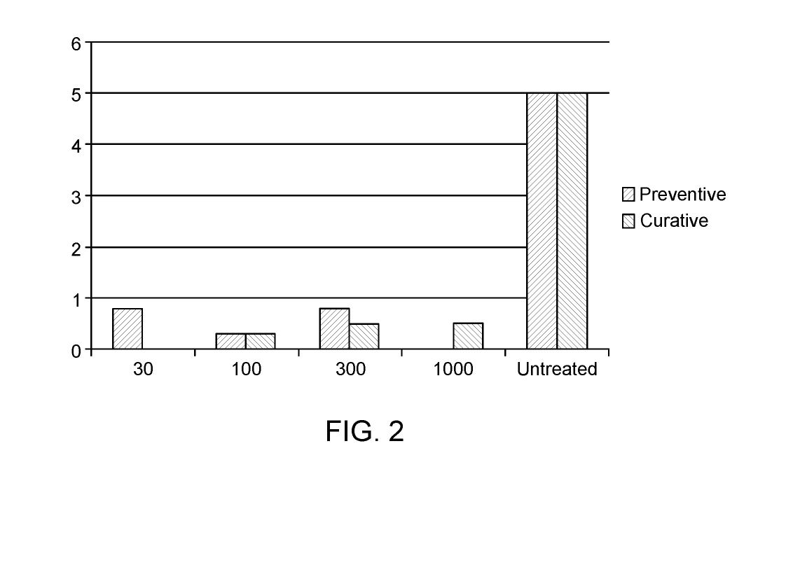

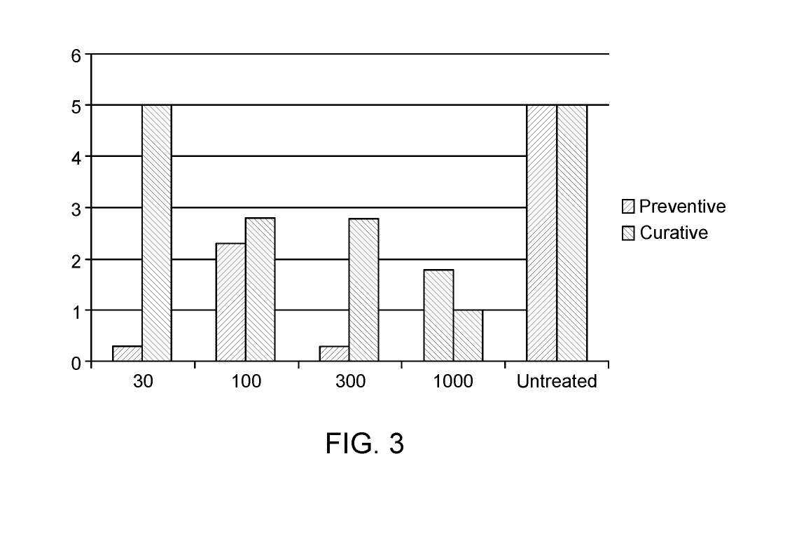

As illustrated in FIGS. 1, 2 and 3, the Biocide B composition demonstrates a clear fungicidal effect against Puccinia striiformis (yellow rust). Furthermore Biocide B has both preventive and curative effect against yellow rust. Addition of detergent/soap does not seem to enhance the effect. Again, somewhat surprisingly, detergent seems to reduce the effect. There is no clear dose response dependency in this trial. The effect of biocide B was aligned with tebuconazole and no phytotoxic effects on the leafs were detected.

### Example 6: Test of Leaf Diseases in Wheat

The purpose was to compare a standard product with systemic fungicides. Another purpose of the study was to evaluate optimal doses of the biocides which could be used for further testing.

The fungicides in this trials were applied with a self-propelled sprayer using low pressure (2.4 bar; Hardi flat fan nozzles, green ISO 015 and 150 l/ha).

Disease assessment was carried out as percent coverage of all green leaves by the individual disease.

Registered disease in Winter wheat: septoria tritici blotch (septoria tritici) powdery mildew (Blumeria graminis) and, yellow rust (Puccinia striiformis).

In most cases, disease assessments in the field was performed using hand held computers (Psion walkabout).

The trials were carried out using the EPPO guidelines. Leaf disease assessments were carried out on whole plants (2-4) leaves or on individual leaves.

### Statistical Analysis

The collected data were subjected to analysis of variance and treatment means were separated at the 95% probability level using F-test.

The soil type in this field study was JB No. 6 is equal to fine clay loam.

### Trial Design

The experimental design was a randomised complete block with 4 replicates and a plot size of 14.4-25.0 m². The layout of the trials is included in the report.

| Test products: | Active ingredient | Batch No.: |
|---|---|---|
| Biocide B | Akacid Forte/Bardap 26 | —/DEG4225402 |
| Bumper 250 EC | Propiconazole 250 g/l | |
| GRA2D082A | | |
| Dithane NT | mancozeb 750 g/kg | UN 3077 |
| MCW 296 SC | folpet 500 g/l | 91113804 |
| Rubric | epoxiconazole 125 g/l | 22130-2040 |

Biocide B (see example 1 above) was used in a doses of 100 ppm.

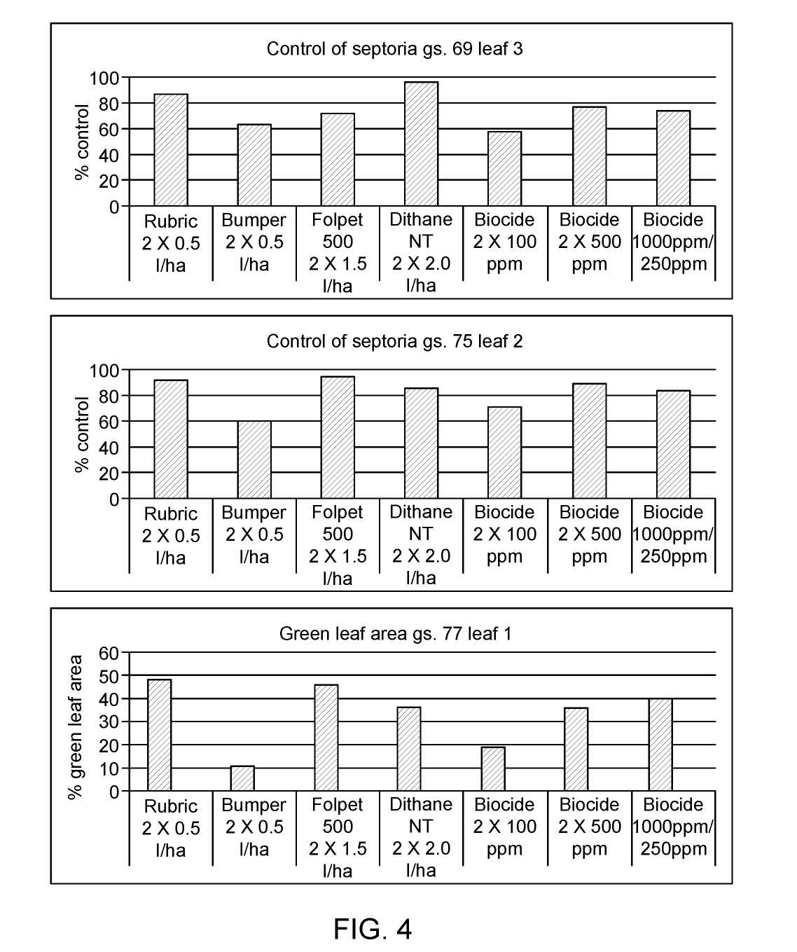

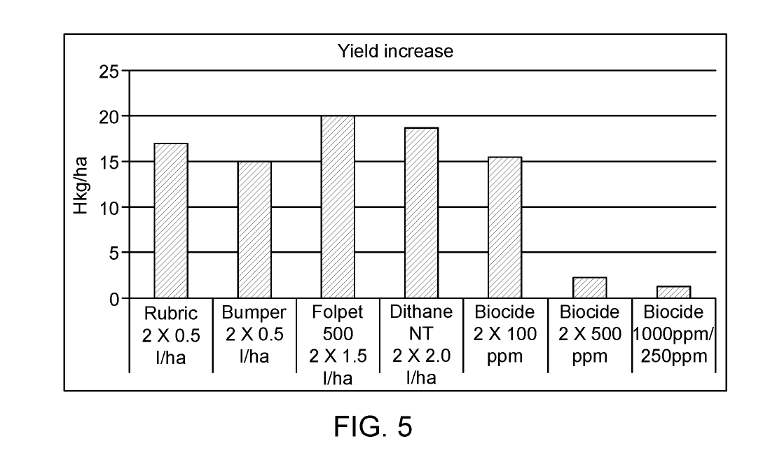

One GEP trial (13312-1) was carried out in 2013 in winter wheat. Trial 13312 was located at Flakkebjerg Research Centre, Denmark in the cultivar Mariboss. The plan aimed at controlling septoria tritici blotch (Septoria tritici) using biocide B at 3 dose rates (100,500 and 1000 ppm) and compared with both systemic (Rubric, Bumper 250 EC) and contact fungicides (Folpet, Dithane (mancoceb). See FIGS. 4 and 5.

### Conclusion

Significant attack of septoria tritici blotch development in the trials. Significant controls were seen from all treatments. The biocide at 100 ppm provided control in line with Bumper 250 EC. Yield levels were moderate to high (75-96 dt/ha) and increases from treatments were positive and significant different from untreated. The low level of the biocide B provide yield in line with Bumper 250 EC, indicating that the product has a potential for providing control of septoria

### Example 7: In Vitro Test Combinations with Known Pesticides

The purpose is to see if biocide B has a synergistic or enhancing effect when used in combination with known pesticides.

Four different known pesticides including 3 azoles and 1 strobilurin are used including Propiconazole (from e.g. Syngenta), Tebuconazole (from e.g. Bayer or Cheminova), Prothioconazole (from e.g. Bayer), and Azoxystrobin (from e.g. Syngenta or Cheminova). Each pesticide is tested in 5 different doses corresponding to 0.05; 0.1; 0.5; 1.0; 5; 10; 50 ppm.

### Overview of the Tested Pesticides are Outlined in the Table Below:

| Biocide A | propi B | tebu C | prothio D | azoxy E | A + B | A + C | A + D | A + E |
|---|---|---|---|---|---|---|---|---|
| 0.05 | 0.05 | 0.05 | 0.05 | 0.05 | 0.1 + 0.05 | 0.1 + 0.05 | 0.1 + 0.05 | 0.1 + 0.05 |
| 0.1 | 0.1 | 0.1 | 0.1 | 0.1 | 0.1 + 0.1 | 0.1 + 0.1 | 0.1 + 0.1 | 0.1 + 0.1 |
| 0.5 | 0.5 | 0.5 | 0.5 | 0.5 | 0.1 + 0.5 | 0.1 + 0.5 | 0.1 + 0.5 | 0.1 + 0.5 |
| 1 | 1 | 1 | 1 | 1 | 0.1 + 1 | 0.1 + 1 | 0.1 + 1 | 0.1 + 1 |
| 5 | 5 | 5 | 5 | 5 | 1.0 + 0.05 | 1.0 + 0.05 | 1.0 + 0.05 | 1.0 + 0.05 |
| 10 | 10 | 10 | 10 | 10 | 1.0 + 0.1 | 1.0 + 0.1 | 1.0 + 0.1 | 1.0 + 0.1 |
| 50 | 50 | 50 | 50 | 50 | 1.0 + 0.5 | 1.0 + 0.5 | 1.0 + 0.5 | 1.0 + 0.5 |
| | | | | | 1.0 + 1.0 | 1.0 + 1.0 | 1.0 + 1.0 | 1.0 + 1.0 |

The fungicide effect is evaluated through two in vitro based setups based on the effect on mycelium growth and spore formation in Fusarium culmorum, Fusarium graminearum, Septoria tritici. All experiments are carried out in triplicates.

Test I: Plugs with a diameter of %2 cm is placed in the middle a each petri dishes. The fungicide effect is evaluated after 2-5 days depending on the growth rates.

Test II: Spore solutions are placed on top of the agar. The fungicide effect is evaluated after 2-5 days depending on the growth rates.

The antifungal effect is evaluated based on the degree of inhibition relative to the untreated samples. Photos of the petri dishes are used for documentation.

### Example 8: In Planta Field Trial Combinations with Bumper 250 EC

The purpose is to evaluate if biocide B (see example 1) has a synergistic or enhancing effect when used in combination with the commercially available fungicide Bumper 250 EC.

The fungicides in this trials are applied with a self-propelled sprayer using low pressure (2.4 bar; Hardi flat fan nozzles, green ISO 015 and 150 l/ha).

Disease assessment is carried out as percent coverage of all green leaves by the individual disease.

Registered disease in Winter wheat: septoria tritici blotch (septoria tritici) powdery mildew (Blumeria graminis) and, yellow rust (Puccinia striiformis).

In most cases, disease assessments in the field are performed using hand held computers (Psion walkabout).

The trials are carried out using the EPPO guidelines. Leaf disease assessments are conducted on whole plants (2-4) leaves or on individual leaves.

### Statistical Analysis

The collected data is subjected to analysis of variance and treatment means are separated at the 95% probability level using F-test.

The soil type in this field study is JB No. 6 which is equal to fine clay loam.

### Trial Design

The experimental design is a randomised complete block with 4 replicates and a plot size of 14.4-25.0 m².

Biocide B (see example 1 above) is used in a dose of 100 ppm.

The trial is located at Flakkebjerg Research Centre, Denmark in the cultivar Mariboss.

| Treatment | Rate (L/ha)* | Growth stage |
|---|---|---|
| Biocide B | 2.25 | ACCRST |
| Biocide B | 1.25 | ACCRST |
| Bumper 250 EC | 0.5 | ACCRST |
| Bumper 250 EC | 0.5 | |
| Biocide B | 1.25 | ACCRST |
| Untreated control | | ACCRST |

### Conclusion

This field trial is expected to demonstrate that Biocide B in combination with the known pesticide, Bumper 250 EC, has a synergistic effect by providing an increased biocidal effect compared to use of either compound alone in same total concentration.

### Example 9: Test Combinations with Other Known Pesticides

Other known pesticides in various concentrations are tested together with biocide B. A non-limiting list of pesticides which are tested in combination with the composition of the present invention are as follows.

Pesticides useful as mixing partners with
the composition of the present invention

| Azoles | SDHI's/strobilurins | Other chemistry |
|---|---|---|
| Prothioconazole | Boscalid | Mancozeb |
| Propiconazole | Bixafen | Folpet |
| Tebuconazole | Other SDHI's | |
| Metconazole | Pyraclostrobin | |
| Epoxiconazole | Azoxystrobin | |

### Example 10: Treatment of Other Microorganisms/Crops

The biocide of the present invention has a preventive and/or curative effect on other microorganisms. A non-limiting list of important diseases and crops in wheat and barley are:

| | | Effect |
|---|---|---|
| Crop | Crop disease (Danish name) | in vivo/vitro |
| Wheat | Puccinia striiformis (Gulrust) | +/+ |
| | Puccinia triticina (Brunrust) | Not tested |
| | Blumeria graminis (meldug) | −/+ |
| | Septoria tritici (Hvedegråplet) | +/+ |
| | Fusarium spp (Aksfusarium) | −/+ |
| Barley | Puccinia hordei (bygrust) | Not tested |
| | Blumeria graminis (meldug) | −/+ |
| | Pyrenophora teres (bygbladplet) | Not tested |
| | Rhynchosporium secalis (skoldplet) | Not tested |
| | Ramularia collo-cygni (ramularia | Not tested |
| | bladplet) | |

In addition to the crops listed above, the composition of the present invention is useful for as a fungicide for treatment of crops such as potato, soy beans, coffee, and various kinds of fruit.

### Example 11: Instruction Forms for the Use of a Composition

The presently disclosed technology focuses on the elimination of pathogen fungi in a number of crops across climatic zones. We provide a disruptive mechanism for protection of crops in agriculture with a very potent efficacy against a variety of fungi and against development of resistance in these fungi.

The composition is preferably in a very high concentration, which will be different from other commercial products, where there will be fraction separation. Therefore it is preferred that the product is being shaken well before use.

The container to be used should be filled with the amount of water described in the dilution section, before the concentrated products are added. After adding the product to the water, then mix with a stirrer, carefully.

Spraying of the product should be done at a minimum of solar intensity, best close to sunset especially in subtropical and tropical areas.

An exemplary composition may comprise an emulgator and
N,N-didecyl-N-methyl-poly(oxyethyl) ammonium propionate and
polyhexamethyleneguanidine hydrochloride

Dilution: The composition should be shaken well before use. The below calculation is based on the use of 150 L/Ha. The concentrate should be diluted for example according to the instructions below, which would also be clearly indicated on the labels of the products.
1) Concentration=100 PPM: Here you take 625 ml of the concentrated solution and bring to 36.9 liters of water (it should be enough for a ¼ Ha).
2) Concentration=50 PPM: Here you take 313 ml of the concentrated solution and bring to 37.2 liters of water (should be enough for a ¼ Ha).
3) Concentration=25 PPM: Here you take 157 ml of the concentrated solution and bring to 37.3 liters of water (should be enough for a ¼ Ha).

### First-Aid-Measures:

After inhalation: Take the person concerned to fresh air.
After skin contact: Wash immediately with water and soap. If symptoms persist obtain medical attention.
After eye contact: Rinse opened eye immediately for 15 minutes under running water.
After swallowing: Drink plenty of water and contact medical service or doctor.

### Example 12: Preparation of Composition

The present experiments shows the results of a composition comprising equimolar amounts of polyhexamethyleneguanidine hydrochloride (Akacide Forte) and N,N-didecyl-N-methyl-poly(oxyethyl) ammonium propionate (Bardap-26). Thus, based on the molar masses of each compound, the amount of the two liquid products to be mixed can be calculated. For example, for polyhexamethyleneguanidine hydrochloride (Akacide Forte) in a 40% solution and N,N-didecyl-N-methyl-poly(oxyethyl) ammonium propionate (Bardap-26) in a 70% solution:

To make 1 liter of product, mix

793 ml polyhexamethyleneguanidine hydrochloride (Akacide Forte) (40%) and 207 ml N,N-didecyl-N-methyl-poly(oxyethyl) ammonium propionate (Bardap-26) (70%).

### Example 13: Plant Protection Test

In vitro tests of plant pathogenic fungi grown on agar

Test Products:
Tilt (propiconazole)
Proline (prothioconazole)
Biocide B (equimolar amounts of polyhexamethyleneguanidine hydrochloride (Akacide forte) and N,N-didecyl-N-methyl-poly(oxyethyl) ammonium propionate (Bardap 26)
Biocide B and 0.1 ppm propiconazole
Biocide B and 0.1 ppm prothioconazole

### 4 Doses:

Biocide: 0.1, 1, 3.3, 10
Propiconazole and prothioconazole: 0.1, 1, 3.3, 10 ppm

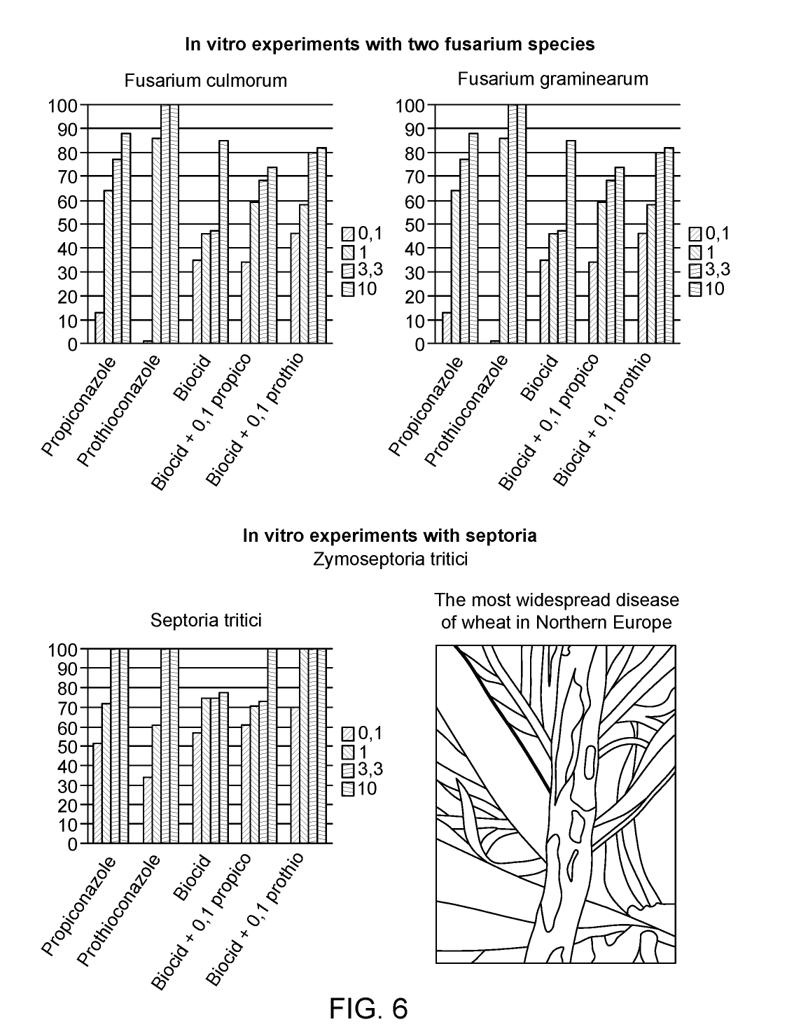

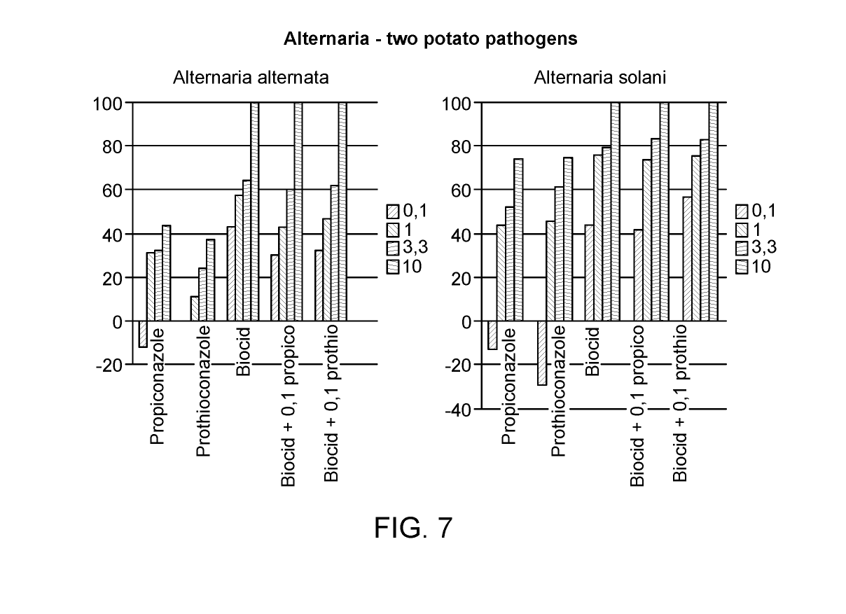

The results are shown in FIGS. 6-7

It is seen that the biocide composition is active against two species of Fusarium. The Biocide is active at lower dosages (0.1 ppm) than the azoles. The Biocide also displays improved power after addition of 0.1 azole in the two middle dosages of the biocide.

For Septoria it is seen that the biocide was more active at the lowest does level (0.1 ppm) compared to azoles. The biocide also shows improved power after adding 0.1 ppm prothioconazole and to a lesser extent propiconazole.

For Alternia, azoles have a low intrinsic power. The biocide is seen to perform much better than the azoles. No improvement is seen by addition of azoles to the biocides.

### Example 13: Field Test on Wheat

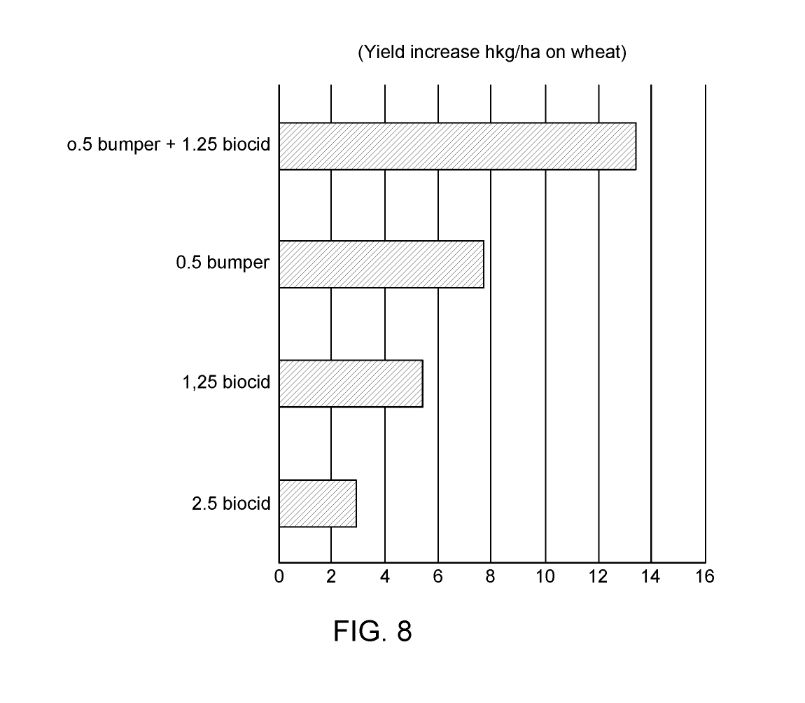

The results are shown in FIG. 8.

The data demonstrated a 45% increase in net yield when combining biocide composition provided herein, comprising equimolar amounts of polyhexamethyleneguanidine hydrochloride (Akacide forte) and N,N-didecyl-N-methyl-poly(oxyethyl) ammonium propionate (Bardap 26), with Bumper 250 EC compared to using Bumper 250 EC alone.

### Example 14: Field Test on Vegetables

The plant protection formula composition provided herein, which comprises equimolar amounts of polyhexamethyleneguanidine hydrochloride (Akacide forte) and N,N-didecyl-N-methyl-poly(oxyethyl) ammonium propionate (Bardap 26) was tested in two locations on Samsø and eastern part of Jutland. It was amongst others tested on red cabbage.

### Red Cabbage:

Red cabbage 50 ppm of biocide with equimolar amounts of polyhexamethyleneguanidine hydrochloride (Akacide forte) and N,N-didecyl-N-methyl-poly(oxyethyl) ammonium propionate (Bardap 26):

Yield: 5.8 kg per meter.=70.020 kg per ha.

The quality is estimated on a scale of 1 to 10 and was here given clear 10 numbers. Cabbages were very uniform, and there was not anyone who had begun signs of rot.

### Red Cabbage 100 ppm of Biocide:

Yield: 4.21 kg per meter.=50.000 kg. Per ha.

The quality rated on the scale of 1 to 10 was estimated to 7. Cabbages were not as uniform as in the parcel with 50 ppm, here there was also some cabbage which had started to rot. (There were some cabbage plants that had been in connection with the cleaning of cabbages, and cause the lower yield)

Red Cabbage without Treatment (Control):

Yield: 4.9 kg Per meter.=59.220 kg. Per ha.

Within the last two weeks could well see that they had not been treated, there was a lot more rotten one in the other two plots, and the cabbages were not the same size as in the treated plots.

The quality is estimated to 5.

The net yield of red cabbage was increased by 18% when using 50 PPM of the biocide comprising equimolar amounts of polyhexamethyleneguanidine hydrochloride (Akacide forte) and N,N-didecyl-N-methyl-poly(oxyethyl) ammonium propionate (Bardap 26).

1.-26. (canceled)

27. A method for treating or preventing a microbial infection in plants, said method comprising the steps of:
a. providing a composition comprising polyhexamethyleneguanidine hydrochloride and N,N-didecyl-N-methyl-poly(oxyethyl) ammonium propionate, and
b. applying an agriculturally effective amount thereof to the plants.

28. The method according to claim 27, said method comprising providing the composition to at least one of the following: the plant, plant foliage, blossoms, stems, fruits, the area adjacent to the plant, soil, seeds, germinating seeds, roots, liquid and solid growth media, and hydroponic growth solutions.

29. The method according to claim 27 for treating or preventing a microbial infection with phytopathogenic fungi.

30. The method according to claim 27, wherein the microbial infection is treated or prevented in harvested fruit, cut flowers, or vegetables.

31. The method according to claim 27, wherein the microbial infection is treated or prevented in fruit and vegetable selected from the group consisting of cereals, beets, pome and stone fruit and berries, leguminous plants, oleaginous plants, cucurbitaceae, fibrous plants, tropical fruit, vegetables, laurel-like plants, maize, tobacco, nuts, coffee, sugar-cane, tea, grapevines, hops, rubber plants, ornamental plants, and evergreen trees.

32. The method according to claim 27 wherein the microbial infection is treated or prevented in soy, wheat, potato, and/or red cabbage.

33. The method according to claim 27, wherein the composition further comprises one or more surfactants selected from the group consisting of non-ionic surfactants and monovalent cationic surfactants.

34. The method according to claim 27, wherein the concentration of N,N-didecyl-N-methyl-poly(oxyethyl) ammonium propionate is in the range from 0.05 to 6000 ppm.

35. The method according to claim 27, wherein the molar ratio of polyhexamethyleneguanidine hydrochloride and N,N-didecyl-N-methyl-poly(oxyethyl) ammonium propionate is from 1:100 to 100:1.

36. The method according to claim 27, wherein said composition further comprises a further pesticide, a fungicide, and/or an insecticide.

37. The method according to claim 36, wherein the further pesticide or fungicide is selected from the group consisting of azoles, prothioconazole, propiconazole, tebuconazole, metconazole, mancozeb, folpet, epoxiconazole, azoxystrobin, and combinations thereof.

38. The method according to claim 27, wherein said composition further comprises one or more chloronitriles, strobilurins, and/or triazoles.

39. The method according to claim 27, wherein said composition is a concentrate composition, which is diluted 100,000, 10,000, 1,000, or 100 times before being applied to the plants.

40. The method according to claim 27, wherein the microbial infection is an infection with a fungus selected from the group consisting of F. avenaceum, F. culmorum, F. graminearum, F. langsethiae, F. oxysporum, F. poae, F. sporotrichioides, F. tricinctum, F. verticillioides, and F. virguliforme.

41. The method according to claim 27, wherein the microbial infection is an infection with a fungus selected from the group consisting of with Fusarium ssp in wheat.

42. The method according to claim 27 for treating or preventing a microbial infection with Alternaria ssp in potato.

43. The method according to claim 27 for treating or preventing a microbial infection with Phakopsora pachyrhizi, P. meibomiae, Pseudomonas savastampo pv. glycinea, Septoria brown spot, Cercospora leaf spot, frogeye leaf spot, Phakopsora pachyrhizi, Cercospora leaf spot, Septoria glycines Hemmi, and/or Peronospora manshurica in soy plants.

44. A plant protection formula comprising polyhexamethyleneguanidine hydrochloride and N,N-didecyl-N-methyl-poly(oxyethyl) ammonium propionate.

45. The plant protection formula of claim 44 further comprising a pesticide, a fungicide, and/or an insecticide.

46. The plant protection formula of claim 45, wherein the further pesticide or fungicide is selected from the group consisting of azoles, prothioconazole, propiconazole, tebuconazole, metconazole, mancozeb, folpet, epoxiconazole, azoxystrobin, and combinations thereof.
